(19) United States
(12) Patent Application Publication
(10) Pub. No.: US 2024/0339116 A1
(43) Pub. Date: Oct. 10, 2024

(54) Mitigating Speech Collision by Predicting Speaking Intent for Participants

(71) Applicant: Google LLC, Mountain View, CA (US)

(72) Inventor: Dongeek Shin, San Jose, CA (US)

(21) Appl. No.: 18/297,288

(22) Filed: Apr. 7, 2023

(51) Int. Cl. G10L 15/24; G10L 15/08

(52) U.S. Cl. CPC G10L 15/24; G10L 15/08

(57) ABSTRACT

Sensor data is obtained from one or more sensors of a participant computing device. The participant computing device and one or more other participant computing devices are connected to a teleconference orchestrated by a teleconference computing system. Based at least in part on the sensor data, a participant associated with the participant computing device is determined to intend to speak to other participants of the teleconference. Information indicating that the participant intends to speak is provided to one or more of the teleconference computing system or at least one of the one or more other participant computing devices.

### FIELD

The present disclosure relates generally to mitigating speech collision (e.g., when two speakers begin to speak concurrently). More specifically, the present disclosure relates to predicting a speaking intent of participants (e.g., of a teleconference, etc.) to mitigate speech collision.

### BACKGROUND

Teleconferencing refers to the live exchange of communication data (e.g., audio data, video data, audiovisual data, textual content, etc.) between multiple participants. Common examples include audioconferences, videoconferences, multimedia conferences (e.g., sharing multiple types of communication data), etc. To participate in a teleconference, a participant can connect to a teleconferencing session using a computing device (e.g., a smartphone, laptop, etc.). The participant can use their device to transmit communication data to a teleconferencing system (e.g., a server system hosting the teleconference, etc.). The teleconferencing system can broadcast the transmitted communication data to the devices of other participants in the teleconferencing session.

### SUMMARY

Aspects and advantages of embodiments of the present disclosure will be set forth in part in the following description, or can be learned from the description, or can be learned through practice of the embodiments.

One example aspect of the present disclosure is directed to a participant computing device. The participant computing device includes one or more processors, one or more sensors, and one or more non-transitory computer-readable media that store instructions that, when executed by the one or more processors, cause the participant computing device to perform operations. The operations include obtaining sensor data from the one or more sensors of the participant computing device, wherein the participant computing device and one or more other participant computing devices are connected to a teleconference orchestrated by a teleconference computing system. The operations include, based at least in part on the sensor data, determining that a participant associated with the participant computing device intends to speak to other participants of the teleconference. The operations include providing information indicating that the participant intends to speak to one or more of the teleconference computing system or at least one of the one or more other participant computing devices.

Another example aspect of the present disclosure is directed to a computer-implemented method. The method includes connecting, by a participant computing device comprising one or more computing devices, to a teleconference orchestrated by a teleconference computing system, wherein the participant computing device is associated with a participant of the teleconference. The method includes receiving, by the participant computing device, information indicating that a second participant of the teleconference intends to speak, wherein the second participant is associated with a second participant computing device that is connected to the teleconference, wherein the information indicating that the participant of the teleconference intends to speak is determined based at least in part on sensor data captured at second participant computing device. The method includes, responsive to the information indicating that the second participant intends to speak, performing, by the participant computing device, one or more actions to indicate, to the participant associated with the participant computing device, that some other participant of the teleconference intends to speak.

Another example aspect of the present disclosure is directed to one or more non-transitory computer-readable media that store instructions that, when executed by one or more processors of a teleconference computing system, cause the teleconference computing system to perform operations. The operations include receiving, from a participant computing device, speaking intent information from a participant computing device of a plurality of participant computing devices connected to a teleconference orchestrated by the teleconference computing system, wherein the speaking intent information indicates that a participant associated with the participant computing device intends to speak. The operations include making an evaluation of one or more indication criteria based on the speaking intent information. The operations include, based on the evaluation, instructing a second participant computing device of the plurality of participant computing devices connected to the teleconference to perform one or more actions to indicate, to a second participant associated with the second participant computing device, that some other participant of the teleconference intends to speak.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an overview data flow diagram for prediction and indication of speaking intent for a participant of a teleconference according to some implementations of the present disclosure.

FIG. 2 is a flow diagram of an example method for performing detection and indication of a participant's speaking intent in a teleconference, in accordance with some embodiments of the present disclosure.

FIG. 3A depicts a more detailed data flow diagram for prediction and indication of speaking intent for a participant of a teleconference according to some implementations of the present disclosure.

FIG. 3B is a block diagram of training an example machine-learned model for detecting performance of a pre-configured speaking intent gesture based on Inertial Measurement Unit (IMU) sensor data according to one implementation of the present disclosure.

FIG. 4 depicts a data flow diagram for managing indication of speaking intent by a teleconference computing system according to some implementations of the present disclosure.

FIG. 5 is a block diagram for example actions performed by a participant computing device to indicate a speaking intent of some other participant to a participant using the participant computing device according to some implementations of the present disclosure.

FIG. 6 depicts a block diagram of an example computing environment that performs determination and indication of speaking intent according to example implementations of the present disclosure.

Reference numerals that are repeated across plural figures are intended to identify the same features in various implementations.

### DETAILED DESCRIPTION

Generally, the present disclosure is directed to predicting a speaking intent of participants (e.g., of a teleconference, etc.) to mitigate speech collision. More specifically, when communicating in-person, it is relatively uncommon for two people to begin speaking at the same time and talk over each other. This is because one potential speaker can determine that another person is about to speak by interpreting the visual cues provided by the potential speaker (e.g., body language, facial expressions, etc.) and then yield to the other person. This manner of social interaction, which is often performed subconsciously, is critical for facilitating real-life conversations in groups of people.

However, speech collision (i.e., two people speaking at the same time) presents a serious problem in the increasingly popular field of teleconferencing. More specifically, when exchanging communication data (e.g., audio data, video data, etc.) over a network in real-time, there is generally a latency, or delay, between transmission and reception of the communication data. Even when this delay is relatively minor, it can substantially increase the chances of speech collision. For example, assume that two participants of a teleconference named John and Judy begin to speak at the same time. If there is a substantial delay associated with the transmission and reception of communication data between the participants, John can continue to speak for the length of that delay before realizing that Judy is also speaking (and vice versa). In turn, this manner of speech collision leads to awkwardness and repeated attempts to defer to the other speaker before continuing. Furthermore, the chances of speech collision are exacerbated due to the nature of teleconferencing, which only facilitates some of the visual cues used by people in real-life conversations (and even then, only with a delay).

Accordingly, implementations of the present disclosure propose mitigating speech collision in teleconferencing by predicting a speaking intent of participants and signaling such intent to other participants. As an example, most participant computing devices (e.g., smartphones, laptops, Augmented Reality (AR)/Virtual Reality (VR) devices, etc.) are equipped with a variety of sensors for determining the position and movement of the device (e.g., accelerometers, gyroscopes, etc.). The participant computing device can obtain sensor data from these sensors, and based on the sensor data, determine that a participant using with the device intends to speak (e.g., by processing the sensor data with a machine-learned model, etc.). For example, the sensor data associated with a participant moving their smartphone closer to their mouth can indicate that the participant intends to speak. Based on the determination, the participant computing device can indicate to other participant devices (or a system hosting the teleconference) that the participant intends to speak. Upon receipt of the indication, the other participant computing devices can indicate to other participants that someone else intends to speak (e.g., via haptic feedback, a message sent to a display device, etc.). In such fashion, implementations of the present disclosure can predict a participant's speaking intent prior to the participant speaking to substantially mitigate the occurrence of speech collision.

Aspects of the present disclosure provide a number of technical effects and benefits. For example, any real-time exchange of communication data during teleconferencing requires the utilization of computing resources (e.g., bandwidth, network resources, energy, compute cycles, memory, etc.). Similarly, time spent participating in inefficient communication sessions can reduce the productivity of software developers and other high-skill workers. The occurrence of speech collision when teleconferencing can substantially extend the length of a teleconferencing session, therefore inefficiently increasing the utilization of computing resources while reducing the productivity of developers and other workers. However, implementations of the present disclosure can mitigate the occurrence of speech collision by determining a speaking intent for a participant and signaling the intent to other participants in a teleconference. By mitigating the occurrence of speech collision, implementations of the present disclosure can substantially reduce the utilization of computing resources and increase the productivity of developers and other workers.

With reference now to the Figures, example implementations of the present disclosure will be discussed in further detail.

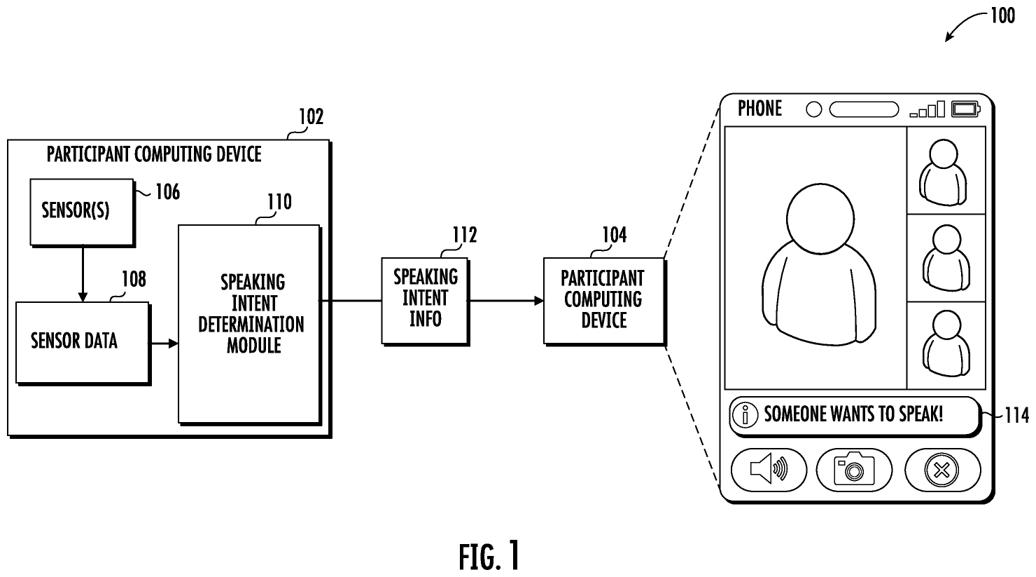

FIG. 1 depicts an overview data flow diagram 100 for prediction and indication of speaking intent for a participant of a teleconference according to some implementations of the present disclosure. More specifically, participant computing devices 102 and 104 can be connected to a teleconference (e.g., an audio conference, videoconference, multimedia conference, AR/VR conference, etc.). For example, the teleconference can be a peer-to-peer (P2P) teleconference orchestrated (i.e., overseen, facilitated, etc.) by a teleconference computing system in which the participant computing devices 102 and 104 directly exchange communication data. For another example, the teleconference can be a teleconference hosted by the teleconference computing system in which the participant computing devices 102 and 104 indirectly exchange communication data.

The participant computing device 102 (e.g., a smartphone, laptop, desktop computer, wearable computing device, AR/VR device, wireless audio output device (i.e., earbuds, headphones, etc.), etc.) can include a variety of different sensor(s) 106. The sensor(s) 106 can include sensor(s) that measure a movement or position of the device (e.g., gyroscope accelerometer, Inertial Measurement Unit (IMU), etc.), sensor(s) that capture communication data (e.g., camera(s), microphone(s), etc.), user input sensor(s) (e.g., button(s), touch surfaces, etc.),

The sensor(s) 106 can provide sensor data 108 to a speaking intent determination module 110. Based on the sensor data 108, the speaking intent determination module 110 can determine whether a participant using the participant computing device 102 intends to speak. For example, in some implementations, the speaking intent determination module 110 can be, or otherwise include, a machine-learned speaking intent model that can process the sensor data 108 to determine whether the participant intends to speak.

If the speaking intent determination module 110 determines that the participant intends to speak, the participant computing device 102 can provide speaking intent information 112 to the participant computing device 104 indicating that the participant intends to speak. In response, the participant computing device 104 can perform an action to indicate that some other participant intends to speak. For example, the participant computing device 104 can make a modification to an interface of an application that facilitates participation in the teleconference that indicates some other participant intends to speak (e.g., displaying an indicative interface element, etc.). In such fashion, implementations of the present disclosure can dynamically determine a speaking intent and signal such intent to other participants to substantially mitigate the occurrence of speech collision during teleconferences.

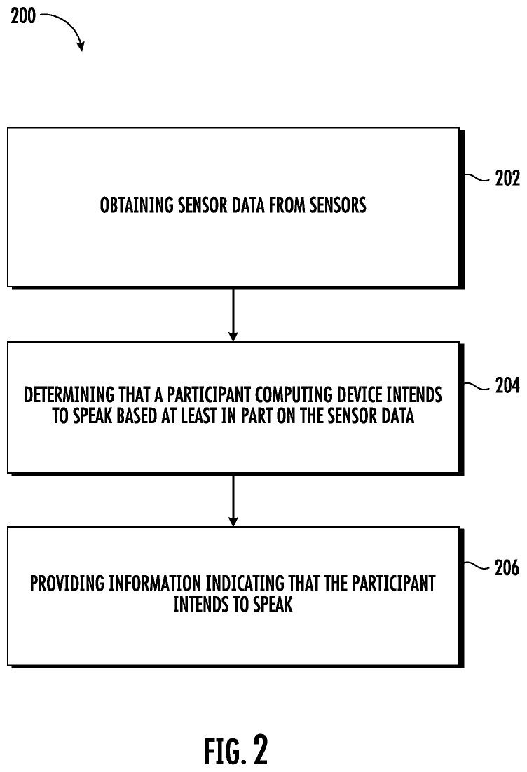

FIG. 2 is a flow diagram of an example method 200 for performing detection and indication of a participant's speaking intent in a teleconference, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the speaking intent determination module 110 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible

At operation 202, processing logic of a participant computing device can obtain sensor data from one or more sensors of the participant computing device. More specifically, the participant computing device can include one or more sensor(s). A sensor can be any type or manner of device that can measure, collect, generate, etc. sensor data and provide the sensor data to the participant computing device. In some implementations, the sensor(s) of the participant computing device can include a gyroscope, accelerometer, or both (e.g., as an IMU) that can measure an orientation, pose, and/or movement of the participant computing device.

For example, assume that the participant computing device is a smartphone device, and the participant has rested the participant computing device on a table as they passively participate in a teleconference. The participant can lift the smartphone from the table and tilt the smartphone towards their mouth in preparation to speak. The movement and changes in orientation of the smartphone can be captured by the sensors of the participant computing device.

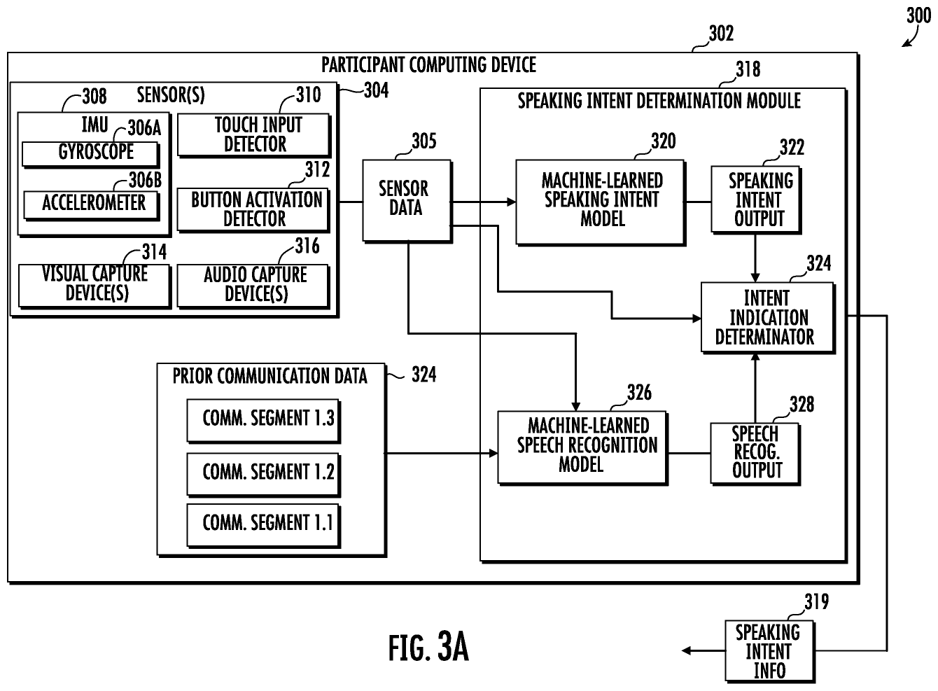

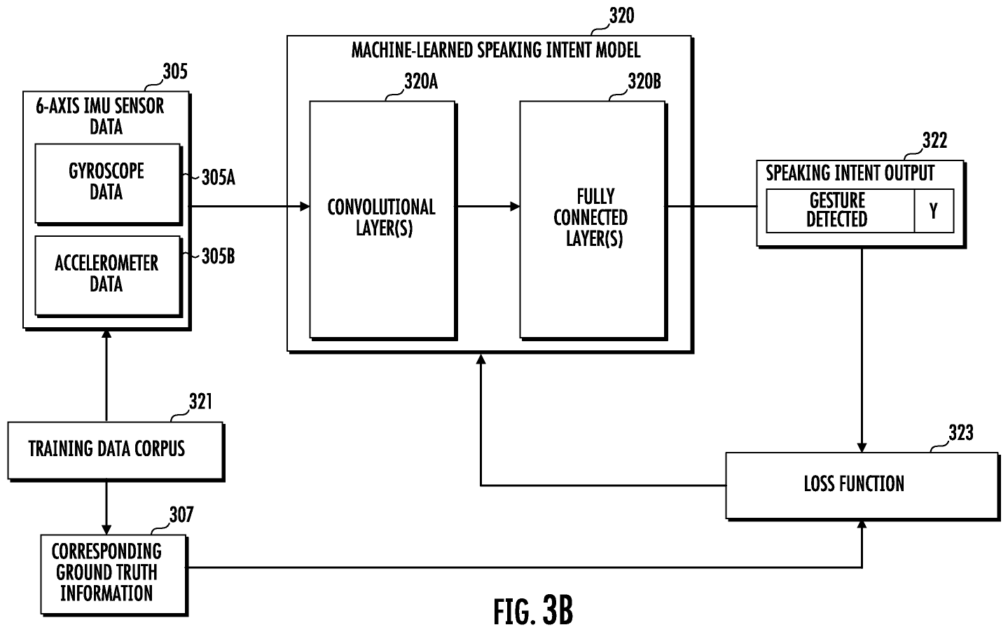

Additionally, or alternatively, in some implementations, the sensor(s) can include communication data capture sensor(s) (e.g., video capture device(s), audio capture device(s), infrared sensor(s), Ultrawideband (UWB) sensor(s), etc.), user input sensor(s) (e.g., button(s), touch surface(s) (i.e., touchscreens, trackpads, etc.), and any other manner of sensor device. The sensor(s) of the participant computing device will be discussed in greater detail with regards to FIG. 3A.

The participant computing device and one or more other participant computing devices can be connected to a teleconference orchestrated by a teleconference computing system. In some implementations, the teleconference can be hosted by the teleconference computing system. For example, the participant computing device can transmit communication data to the teleconference computing system. The teleconference computing system can process the communication data (e.g., decode, encode, etc.) and broadcast the communication data to other participant computing devices connected to the teleconference. Alternatively, in some implementations, the teleconference computing system can facilitate direct P2P communications between the participant computing devices. The teleconference to which the participant computing device is connected can be any type or manner of teleconference in which audio data is exchanged (e.g., a videoconference, multimedia conference, AR/VR conference, etc.).

Communication data generally refers to data that carries communications between participants. Communication data can be transmitted between participant computing devices (e.g., directly or indirectly via an intermediary) to facilitate communication between participants associated with the participant computing devices. Communication data can include audio data, video data, image data, audiovisual data, textual data, AR/VR data (e.g., pose data, etc.) or any other type or manner of data that can convey a communicative intent (e.g., emojis or other representations of particular emotions, feelings, and/or actions, animated images, etc.

At operation 204, the processing logic of the participant computing device can, based at least in part on the sensor data, determine that a participant associated with the participant computing device intends to speak to other participants of the teleconference. More specifically, the participant computing device can determine that the participant using the participant computing device intends to speak imminently. In some implementations, the participant computing device can include, or can communicatively access (e.g., via a wireless network) a machine-learned speaking intent model (e.g., a neural network, etc.). The machine-learned speaking intent model can be trained to process sensor data to determine whether a participant intends to speak. To follow the previous example, the sensor(s) (e.g., the accelerometer and/or gyroscope) can capture sensor data corresponding to movement of the smartphone towards the participant's face. The participant computing device can process the sensor data with the machine-learned speaking intent model to obtain a speaking intent output (e.g., a classification output, etc.). The speaking intent output can indicate that the participant does intend to speak. The machine-learned speaking intent model will be discussed in greater detail with regards to FIG. 3B.

Additionally, in some implementations, the participant computing device can determine whether the participant intends to speak based on communication data that was transmitted or received previously. For example, the participant computing device can receive audio data (e.g., from an audio capture device associated with the participant computing device, from some other participant computing device, etc.), and can process the audio data with a machine-learned speech recognition model. The machine-learned speech recognition model can be a model that is trained to determine whether a conversation between participants is ending (e.g., has already ended, will end within a threshold period of time, etc.). Based on the output of the model, and the sensor data, the participant computing device can determine that the participant intends to speak. Further, in some implementations, speech recognition data can be considered when determining a speaking intent. For example, speech recognition data may indicate that a conversation between two participants is likely to end within a certain period of time, or has already ended.

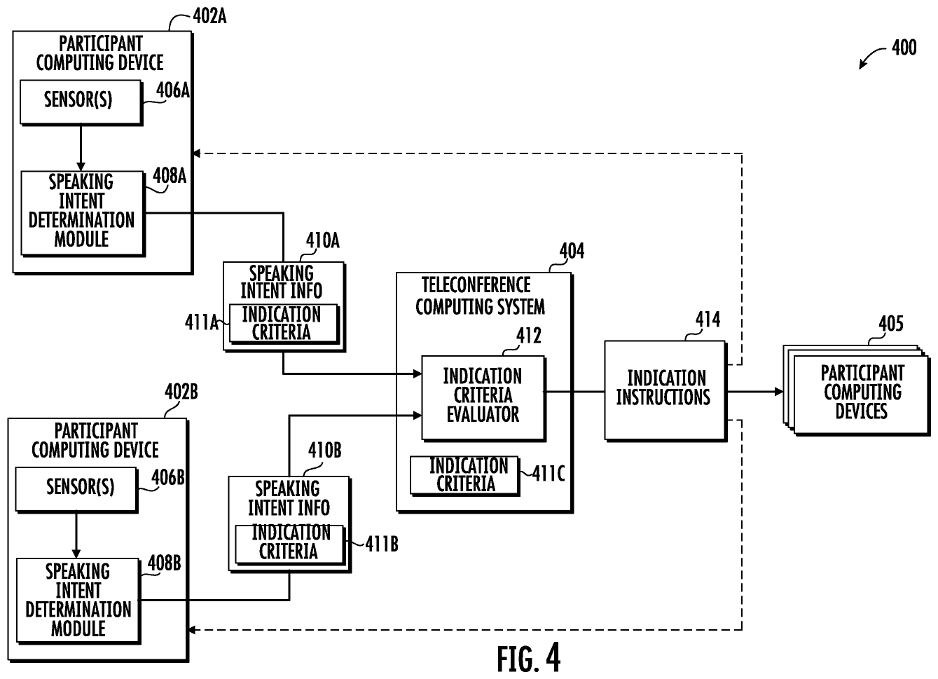

At operation 206, the processing logic of the participant computing device can provide information indicating that the participant intends to speak to (a) the teleconference computing system, and/or (b) one (or more) of the other participant computing devices. For example, the participant computing device can provide information to the teleconference computing system indicating that the participant intends to speak. The teleconference computing system can provide indication instructions to the other participant computing devices(s) that instruct the devices to perform actions to indicate the speaker's intent. For another example, the participant computing device can directly provide indication instructions to the other participant computing device(s). Provision of speaking intent information and indication instructions will be discussed in greater detail with regards to FIG. 4.

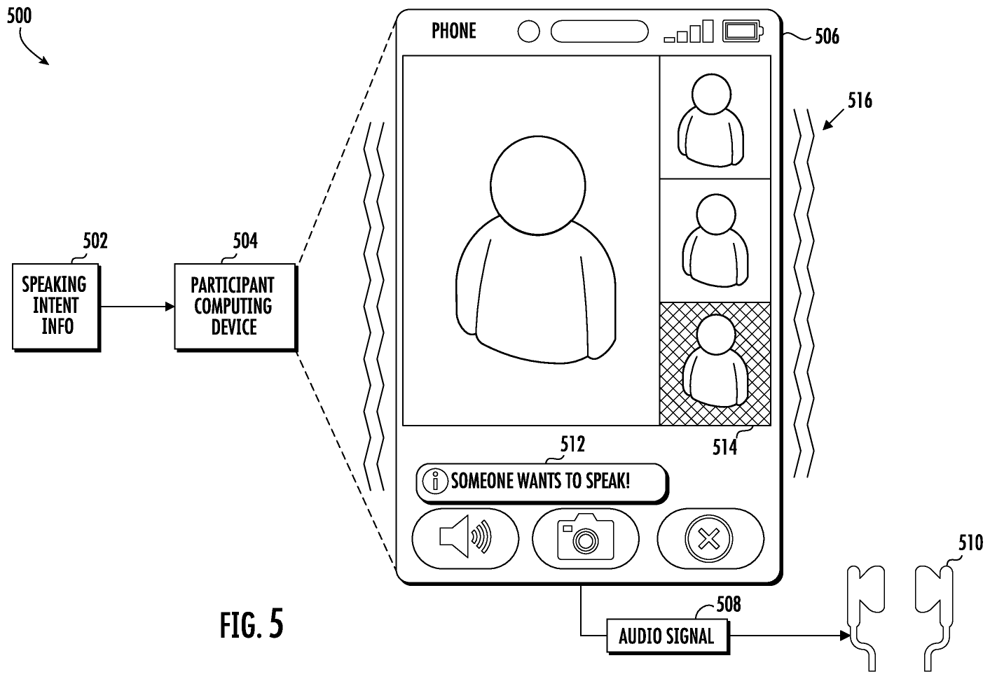

In some implementations, the participant computing device can receive information from some other participant computing device indicating that some other participant intends to speak. In response, the participant computing device can perform action(s) to indicate, to the participant associated with the participant computing device, that some other participant of the teleconference intends to speak. For example, the participant computing device can generate a haptic feedback signal (e.g., a vibration, etc.) indicating to the participant that some other participant intends to speak. For another example, the participant computing device can cause playback of audio that indicates to the participant that some other participant intends to speak. For yet another example, the participant computing device can display an interface element that indicates to the participant that some other participant intends to speak. Performance of actions to indicate a speaking intent will be discussed in greater detail with regards to FIG. 5.

FIG. 3A depicts a more detailed data flow diagram 300A for prediction and indication of speaking intent for a participant of a teleconference according to some implementations of the present disclosure. More specifically, a participant computing device 302 (e.g., participant computing device 102 of FIG. 1, etc.) can include sensor(s) 304. The sensor(s) 304 can be any type or manner of device capable of collecting and providing sensor data 305 to the participant computing device 302. In some implementations, the sensor(s) 304 can include a gyroscope 306A. The gyroscope 306A can collect sensor data 305 that describes or otherwise indicates a linear orientation of the participant computing device 302. The sensor(s) 304 can also include an accelerometer 306B. The accelerometer 306B can measure a magnitude and direction of acceleration of the participant computing device 302 and provide the measurements as sensor data 305 to the participant computing device 302.

In some implementations, the gyroscope 306A, the accelerometer 306B, and/or other sensors that measure physical characteristics of the participant computing device 302 (e.g., a magnetometer, etc.) can be included in an Inertial Measurement Unit (IMU) 308. The IMU 308 can collect information from the gyroscope 306A, the accelerometer 306B, and/or other sensor(s) and provide the collective sensor data 305 to the participant computing device 302. In some implementations, the IMU 308 can perform various processing or pre-processing operations to the sensor data 305 prior to providing the sensor data 305 to the participant computing device 302. For example, the IMU 308 can process information from both the gyroscope 306A and accelerometer 306B to generate sensor data 305 that is descriptive of both a current state and a predicted state of the participant computing device 302.

In some implementations, the sensor(s) 304 can include a touch input detector 310. The touch input detector 310 can collect and provide sensor data 305 that indicates interactions between touch surface(s) of the participant computing device 302 and the participant using the participant computing device 302 (e.g., a touchscreen device, a trackpad device, a touch-sensitive outer housing of the participant computing device 302, etc.). For example, the participant computing device 302 can include a touch display. The participant using the participant computing device 302 can perform touch input(s) (e.g., touching a user input element on the display, performing a touch gesture, etc.) corresponding to an intent to speak (e.g., a pre-configured speaking intent gesture, a movement or series of movements corresponding to an intent to speak, etc.). The touch input detector 310 can collect and provide sensor data 305 that describes the touch gestures performed by the participant.

For another example, the participant computing device 302 can be a pair of wireless earbuds, or can be a smartphone communicatively coupled to a pair of wireless earbuds. The participant can perform a touch gesture to a touch surface of the outer housing of the wireless earbuds. The touch input detector 310 can collect sensor data 305 that describes the touch gesture and provide the sensor data to the participant computing device 302.

In some implementations, the sensor(s) 304 can include a button activation detector 312. The button activation detector 312 can detect when button input devices are activated by a participant using the participant computing device 302. For example, the participant computing device 302 can be a smartphone with a power button. The participant computing device 302 can be pre-configured to indicate a speaking intent when the power button is pressed in a particular pattern (e.g., pressed three times in rapid succession, etc.). The button activation detector 312 can detect interactions between the power button and the user, and can provide sensor data 305 that describes the interactions to the participant computing device 302.

In some implementations, the sensor(s) 304 can include visual capture device(s) 314 (e.g., camera(s), infrared sensor(s), mmWave sensor(s), etc.). The visual capture device(s) 314 can be the sensor(s) used to capture video data depicting the participant for purposes of facilitating the teleconference (e.g., transmitting video data in a videoconference scenario, etc.). For example, assume that the participant computing device 302 is being used to participate in a videoconference (e.g., the real-time exchange of audio and video data), and that the participant is capturing video data that depicts at least a portion of their body, such as their face. The participant can perform a bodily movement (e.g., a facial expression, an articulation of limb(s), etc.) that corresponds to a speaking intent. The sensor data 305 can be, or otherwise include, the video data or at least a portion of the video data (e.g., a subset of frames from the video data) that depicts the bodily movement.

In some implementations, the sensor(s) 304 can include audio capture device(s) 316. The audio capture device(s) 316 can be the sensor(s) used to capture audio data including audio produced by the participant for purposes of facilitating the teleconference (e.g., transmitting audio data in a teleconferencing scenario, etc.). For example, assume that the participant computing device 302 is being used to participate in an audio conference (e.g., the real-time exchange of at least audio data). The participant can produce audio (e.g., a spoken utterance, etc.) that corresponds to a speaking intent. The sensor data 305 can be, or otherwise include, the audio data or at least a portion of the audio data that includes or otherwise represents the audio.

The participant computing device 302 can utilize a speaking intent determination module 318 to generate speaking intent information 319 based at least in part on the sensor data 305. More specifically, the speaking intent determination module 318 can determine whether the participant using the participant computing device 302 intends to speak. It should be noted that, as described herein, the speaking intent determination module 318 does not necessarily determine whether a participant intends to speak within a certain period of time (e.g., within 5 seconds, 10 seconds, etc.). Rather, the speaking intent determination module 318 can determine whether the sensor data 305 captured by the sensors 304 corresponds to a “speaking intent”. More generally, the speaking intent determination module 318 can determine whether the action(s) of the participant, as captured by the sensor data 305, represent a “speaking intent”.

Furthermore, in some implementations, the speaking intent determination module 318 can be configured to detect the performance of a pre-configured speaking intent gesture. More specifically, in some implementations, an application associated with the teleconference, or the operating system of the participant computing device 302, can provide the capability for participants to associate the performance of certain actions or gestures with indication of a speaking intent. For example, a participant can associate movement(s) of the participant computing device 302 with an indication of speaking intent (e.g., shaking the participant computing device 302, tapping a surface of the participant computing device 302, tilting or otherwise altering the orientation of the participant computing device 302, etc.). For another example, a participant can associate certain spoken utterances performed when the participant computing device 302 is set to a “muted” state with indication of speaking intent (e.g., saying “I want to speak” while the device is muted, etc.). For another example, a participant can associate the performance of certain facial expressions, body movements, etc. with indication of speaking intent (e.g., raising a hand, etc.). For yet another example, a participant can associate certain inputs or input sequences with indication of speaking intent (e.g., pressing a button of the participant computing device 302 three times in rapid succession, etc.).

In some implementations, the speaking intent determination module 318 can determine whether the participant intends to speak using a machine-learned speaking intent model 320. The machine-learned speaking intent model 320 can be a model (e.g., neural network, recurrent neural network (RNN), etc.) that is trained to process sensor data to determine whether a participant intends to speak. More specifically, in some implementations, the machine-learned speaking intent model 320 can be trained to detect the occurrence of a pre-configured speaking intent gesture. For example, the pre-configured speaking intent gesture can be a series of tapping motions performed on a touch surface of the participant computing device 302. The sensor data 305 can be data from the touch input detector 310. The machine-learned speaking intent model 320 can process the sensor data 305 to obtain (i.e., generate, etc.) a speaking intent output 322. The speaking intent output 322 can indicate performance of the pre-configured speaking intent gesture by the participant.

In some implementations, the machine-learned speaking intent model 320 can be trained to evaluate whether performance of a speaking intent gesture is intentional. For example, assume that the pre-configured speaking intent gesture is a series of tapping motions performed on the touch surface of the participant computing device 302. The participant can perform the series of tapping motions, which can be captured as sensor data 305 by the touch input detector 310. However, IMU 308 can capture sensor data 305 that indicates a substantial amount of motion of the participant computing device 302 that corresponds to a participant walking. The machine-learned speaking intent model 320 can process the sensor data 305 to obtain the speaking intent output 322. The speaking output 322 can indicate that although the pre-configured speaking intent gesture was performed by the participant, it is likely that the pre-configured speaking intent gesture was performed unintentionally (e.g., due to the participant computing device 302 being stored in a pocket of the participant, etc.).

As another example, the pre-configured speaking intent gesture can be physical motion performed by the participant in which the participant computing device 302 is tilted to a certain angle. However, the sensor data 305 from the IMU 308 can indicate that the participant computing device 302 is rapidly changing angles of orientation in an unintentional manner (e.g., the participant computing device 302 is a smartphone being used by the participant on a public transportation vehicle and the vehicle is causing the rapid change in angles of orientation). The machine-learned speaking intent model 320 can process the sensor data 305 to obtain the speaking intent output 322, which can indicate that the pre-configured speaking intent gesture has not been performed by the participant.

As yet another example, the pre-configured speaking intent gesture can be the rapid activation of a button sensor twice while moving the participant computing device 302 towards the participant's face. The button activation detector 312 can collect sensor data 305 indicating that the button sensor has been activated twice in rapid succession. The IMU 308 can capture sensor data 305 that indicates a pattern of movement corresponding to movement of the participant computing device 302 towards the participant's face. However, the visual capture device 314 can be a front-facing device that captures sensor data 305 (e.g., video data, mmWave data, etc.) that does not depict or indicate the presence of the participant. The machine-learned speaking intent model 320 can process the sensor data 305 to obtain the speaking intent output 322. The speaking intent output 322 can indicate that, as the presence of the participant's face cannot be detected in the sensor data 305 from the visual capture device(s) 314, the sensor data 305 captured by the IMU 308 does not correspond to movement of the participant computing device 302 towards the participant's face, and as such, the pre-configured speaking intent gesture has not been performed.

Alternatively, in some implementations, the speaking intent determination module 318 can be configured to determine whether actions performed by the participant are indicative of a speaking intent. In other words, the participant computing device 302 can utilize the machine-learned speaking intent model 320 to determine whether the participant intends to speak without pre-configuration of a speaking intent gesture. For example, the participant can move the participant computing device 302 towards their face as if preparing to speak. The IMU 308 can collect sensor data 305 that captures the movement of the participant computing device 302 towards the participant's face. The machine-learned speaking intent model 320 can process the sensor data 305 to obtain the speaking intent output 322. The speaking output 322 can indicate that, based on the movements of the participant computing device 302, the participant intends to speak.

As another example, the participant can make a facial expression as if preparing to speak. The visual capture device 314 can collect sensor data 305 that captures the participant's facial expression. The machine-learned speaking intent model 320 can process the sensor data 305 to obtain the speaking intent output 322. The speaking output 322 can indicate that, based on the facial expression of the participant indicated by the sensor data 305, the participant intends to speak.

As yet another example, the participant can make an attempt at speaking (e.g., speak the first syllable(s) of a word) before abandoning the attempt because some other participant is still speaking. The audio capture device(s) 316 can capture sensor data 305 that includes audio of the attempt at speaking. The machine-learned speaking intent model 320 can process the sensor data 305 to obtain the speaking intent output 322. The speaking output 322 can indicate that the participant intends to speak based on the attempt to speak made by the participant as indicated by the sensor data 305.

In some implementations, the machine-learned speaking intent model 320 can be a model specifically trained to process sensor data 305 from the IMU 308 to determine whether movements of the participant computing device 302 correspond to a speaking intent of the participant. The machine-learned model(s) utilized in such implementations will be discussed in greater detail with regards to FIG. 3B.

It should be noted that the machine-learned speaking intent model 320 can be any type, manner, or grouping of machine-learned model(s) to collectively perform the task of determining a speaking intent of a participant. For example, in some implementations, the machine-learned speaking intent model 320 can be a single neural network trained to interpret sensor data 305 from an IMU 308. Alternatively, in some implementations, the machine-learned speaking intent model 320 can be a grouping of models trained to process specific types of sensor data 305. For example, the machine-learned speaking intent model 320 can be or otherwise include a model (e.g., a submodel, portion of the machine-learned speaking intent model 320, etc.) that is trained to detect the presence of a participant in sensor data 305 collected from visual capture device(s) 314. For another example, the machine-learned speaking intent model 320 can be or otherwise include a model trained to process sensor data 305 from audio capture device(s) 316 to determine a semantic intent of spoken utterances captured in the sensor data 305 (i.e., a semantic intent of words produced by the participant). For another example, the machine-learned speaking intent model 320 can be or otherwise include a model trained to process sensor data 305 from the touch input detector 310 to detect performance of certain touch gestures.

Additionally, it should be noted that although the machine-learned speaking intent model 320 is discussed primarily within the context of local inference phase processing, at least some of the machine-learned speaking intent model 320 can be located on a system or device separate from the participant computing device 302. For example, the machine-learned speaking intent model 320, or submodel(s) of the machine-learned speaking intent model 320, can be located on a remote computing system (e.g., a virtualized cloud device, a compute node within a wireless network, etc.) that is remote from the participant computing device 302. The participant computing device 302 can transmit sensor data 305, or an encoding of the sensor data 305, to the remote computing system and the remote computing system can return a speaking intent output 322 to the participant computing device 302 obtained using the machine-learned speaking intent model 320.

In some implementations, the participant computing device 302 can store prior communication data 324. The prior communication data 324 can include segments of prior communication data previously transmitted to the participant computing device 302 during participation in the teleconference. For example, a segment of prior communication data can be the last 10 seconds audio data transmitted to the participant computing device 302. The speaking intent determination module 318 can include or otherwise utilize a machine-learned speech recognition model 320 that is trained to process communication data 326 to obtain a speech recognition output 328 (i.e., generate, etc.). The speech recognition output 328 can indicate whether a conversation between other participants of the teleconference has ended.

In some implementations, the speaking intent determination module 318 can include an intent indication determinator 330. The intent indication determinator 330 can determine whether to indicate a speaking intent of the participant using the participant computing device 302 to other participant computing devices connected to the teleconference, or to the teleconference computing system orchestrating the teleconference. To do so, the intent indication determinator 330 can utilize sensor data 305, speaking intent 322, and other data or information, such as the speech recognition output 328.

For example, assume that the speaking intent output 322 indicates that the participant intends to speak. However, the speech recognition output 328 indicates that a currently ongoing conversation between other participants of the teleconference has not ended and is not likely to end imminently. The intent indication determinator 330 can determine to refrain from generating speaking intent information 319 until the conversation between the other participants has ended or is likely to end imminently.

For another example, assume that the speaking intent output 322 indicates that the participant intends to speak. The speech recognition output 328 indicates that a conversation between other participants of the teleconference has just ended. The intent indication determinator 330 can determine to indicate a speaking intent, and based on the determination, the participant computing device 302 can generate the speaking intent information 319. Transmission of the speaking intent information, either to an orchestrating teleconference computing system or directly to other participant computing device(s) connected to the teleconference, will be discussed in greater detail with regards to FIG. 4.

FIG. 3B is a block diagram 300B of training an example machine-learned model for detecting performance of a pre-configured speaking intent gesture based on IMU sensor data according to one implementation of the present disclosure. More specifically, 6-axis IMU sensor data 305 (e.g., sensor data collected from an IMU that measure movement upon 6 axes) can include gyroscope data 305A (e.g., 3-axis gyroscope data) and accelerometer data 305B (e.g., 3-axis accelerometer data) as described with regards to FIG. 3A. The machine-learned speaking intent model 320 can be, or otherwise include, a neural network. More specifically, the machine-learned speaking intent model 320 can include convolutional layer(s) 320A and fully connected layer(s) 320B. For example, the convolutional layer(s) 320A can be, or otherwise include, a multi-headed series of 1D convolutional blocks.

The 6-axis IMU sensor data 305 can be obtained from a corpus of training data 321. The corpus of training data 321 can include multiple training pairs that each include 6-axis IMU sensor data 305 and corresponding ground truth information 307. The 6-axis IMU sensor data 305 can correspond to a movement or series of movements, and the corresponding ground truth information 307 can indicate whether the movement(s) correspond to intentional performance of a pre-configured speaking intent. For example, one training pair can include 6-axis IMU sensor data 305 collected when intentionally performing a pre-configured speaking intent gesture, and the corresponding ground truth information 307 can indicate that the pre-configured speaking intent gesture was performed intentionally. For another example, another training pair can include 6-axis IMU sensor data 305 collected when unintentionally performing a pre-configured speaking intent gesture, and the corresponding ground truth information 307 can indicate that the pre-configured speaking intent gesture was performed, but was performed unintentionally. For yet another example, another training pair can include 6-axis IMU sensor data 305 collected when performing movement(s) that are different than a pre-configured speaking intent gesture, and the corresponding ground truth information 307 can indicate that the pre-configured speaking intent gesture is not performed.

To train the machine-learned speaking intent model 320, the 6-axis IMU sensor data 305 can be processed with the machine-learned speaking intent model 320 to obtain speaking intent output 322. A loss function 323 can evaluate a difference between the speaking intent output 322 and the corresponding ground truth information 307. Based on the difference, the values of parameter(s) of the machine-learned speaking intent model 320 can be modified. In such fashion, a machine-learned speaking intent model 320 can be trained to detect the intentional performance of multiple pre-configured speaking intent gestures.

FIG. 4 depicts a data flow diagram 400 for managing indication of speaking intent by a teleconference computing system according to some implementations of the present disclosure. More specifically, participant computing devices 402A and 402B (generally, participant computing devices 402) can be connected to a teleconference hosted by teleconference computing system 404 along with a number of other participant computing devices 405. Both participant computing devices 402A and 402B can respectively include sensor(s) 406A and 406B (generally, sensors 406) and speaking intent determination modules 408A and 408B (generally, speaking intent determination modules 408). The sensors 406 of the participant computing devices 402 can collect sensor data, and the participant computing devices 402 can process the sensor data with the speaking intent determination modules 408 to determine whether the participants associated with the participant computing devices 402 intend to speak.

Both participant computing devices 402A and 402B can respectively provide speaking intent information 410A and 410B (generally, speaking intent information 410) to the teleconference computing system 404. However, in some instances, both speaking intent information 410A and 410B can indicate that a participant intends to speak. In such instances, the teleconference computing system 404 can select one of the participants for indication of intent to the other participant computing devices 405.

The speaking intent information 410 can be any manner of data that indicates a speaking intent of a participant. For example, the speaking intent information 410 can be a data object, such as a JSON object, that stores information in a format that indicates the speaking intent. For another example, the speaking intent information can be an output from a machine-learned model.

More specifically, the teleconference computing system 404 can evaluate indication criteria 411A, 411B, and 411C (generally, indication criteria 411). For example, in some implementations, the speaking intent information 410A and 410B can respectively describe indication criteria 411A and 411B, and the teleconference computing system 404 can store indication criteria 411C based on prior interactions with participant computing devices. The teleconference computing system can evaluate the indication criteria 411 with indication criteria evaluator 412 to determine which participant to indicate as an intended speaker.

The indication criteria 411 can be any type or manner of information or metric(s) associated with the participant computing devices 402 and/or prior interactions with the teleconference computing system 404. In some implementations, the indication criteria 411 can be a number of times that a speaking intent has been previously indicated for the participants associated with the participant computing devices 402. For example, the indication criteria 411C can indicate a number of times that a speaking intent has been previously indicated for a participant associated with the participant computing device 402A.

Additionally, or alternatively, in some implementations, the indication criteria 411 can be a degree of certainty associated with speaking intent information. For example, the speaking intent determination module 408A of the participant computing device 402A can determine with a 60% confidence metric that the participant intends to speak, while the speaking intent determination module 408B of the participant computing device 402B can determine with a 95% confidence metric that the participant intends to speak. The speaking intent information 410 can describe the confidence metrics determined by the speaking intent determination modules 408 to the teleconference computing system 404.

Additionally, or alternatively, in some implementations, the indication criteria 411 can be a quality metric associated with a participant computing device. For example, the quality metric can be a connection quality metric associated with a connection of the participant computing device to the teleconference. For another example, the quality metric can be an average transmission latency for a participant computing device. For another example, the indication criteria 411 can indicate an average rate of dropped packets from a participant computing device, a quality of an associated microphone associated with a participant computing device, etc.

Additionally, or alternatively, in some implementations, the indication criteria 411 can be a number of other participant computing devices that have also provided speaking intent information to the teleconference computing system 404. For example, the indication criteria 411C can describe a number and identity of participant computing devices that have transmitted speaking intent information 410 indicating that a participant intends to speak.

Based on indication criteria 411, the indication criteria evaluator can determine which participant computing device(s) to transmit indication instructions 414 to. For example, assume that the indication criteria evaluator 412 determines to indicate a speaking intent of the participant associated with participant computing device 402A. The teleconference computing system 404 can then transmit indication instructions 414 to the participant computing device 402B and the other participant computing devices 405. Alternatively, if the indication criteria evaluator 412 determines to indicate a speaking intent of the participant associated with participant computing device 402B, the teleconference computing system 404 can transmit indication instructions 414 to the participant computing device 402A and the other participant computing devices 405. In such fashion, the teleconference computing system 404 can resolve any conflicts caused by multiple participant computing devices 402 indicating a speaking intent of an associated participant.

FIG. 5 is a block diagram 500 for example actions performed by a participant computing device to indicate a speaking intent of some other participant to a participant using the participant computing device according to some implementations of the present disclosure. More specifically, speaking intent information 502 can be generated (e.g., as described with regards to FIG. 3A) and transmitted to a participant computing device 504. The participant computing device 504, as depicted, can be a smartphone device that includes a display device. The display device can display an interface 506 for an application that facilitates participation in a teleconference to which the participant computing device 504 is connected. The participant computing device 504 can also be communicatively coupled (e.g., via cables, a wireless connection, etc.) to an audio output device 510 (e.g., wireless earbuds, wired earbuds, headphones, audio output devices of an AR/VR device, speakers, etc.).

As described previously, the participant computing device 504 can be a device used by a participant to connect to the teleconference and facilitate participation within the teleconference. Upon receipt of the speaking intent information 502 (e.g., from a teleconference computing system orchestrating the teleconference, from some other participant computing device, etc.), the participant computing device 504 can perform action(s) to indicate to the participant that some other participant of the teleconference intends to speak.

In some implementations, the action(s) can include causing playback of audio with an audio output device associated with the participant computing device. For example, the participant computing device 504 can generate an audio signal 508 that, when played, produces audio indicative of a speaking intent of some other participant (e.g., a gentle “ping” sound or tone, etc.). The participant computing device 504 can provide the audio signal 508 to an audio output device 510 associated with the participant computing device 504 to cause playback of the audio signal (e.g., speaker devices built into the participant computing device 504, wireless earbuds that are actively connected to the participant computing device 504, etc.).

Additionally, or alternatively, in some implementations, the action(s) can include making a modification to the interface 506. For example, the participant computing device 504 can generate an interface element 512 that explicitly indicates a speaking intent of some other participant to the participant using the participant computing device 504. The participant computing device 504 can modify the interface 506 to display the interface element 512. For another example, the interface 506 can depict representations of participants of the teleconference (e.g., video feeds, images, avatars, “default” or “placeholder” images, etc.). The participant computing device 504 can make a modification 514 to the depicted representation of the other participant to indicate that that participant intends to speak (e.g., a “glowing” effect around the border of the representation, increasing the size of the representation, dynamically moving the representation within the interface, etc.).

Additionally, or alternatively, in some implementations, the action(s) can include generating a haptic feedback signal for haptic device(s) associated with the participant computing device 504. The haptic feedback signal can indicate that some other participant intends to speak. For example, the participant computing device 504 can include a linear actuator device. The participant computing device 504 can instruct generate a haptic feedback signal that causes the linear actuator to actuate to produce a vibration effect 516 that indicates to the participant using the participant computing device 504 that some other participant wants to speak. Alternatively, the participant computing device 504 can generate the haptic feedback signal for some other haptic feedback device (e.g., a linear actuator or the like within wireless earbuds communicatively coupled to the participant computing device 504, etc.).

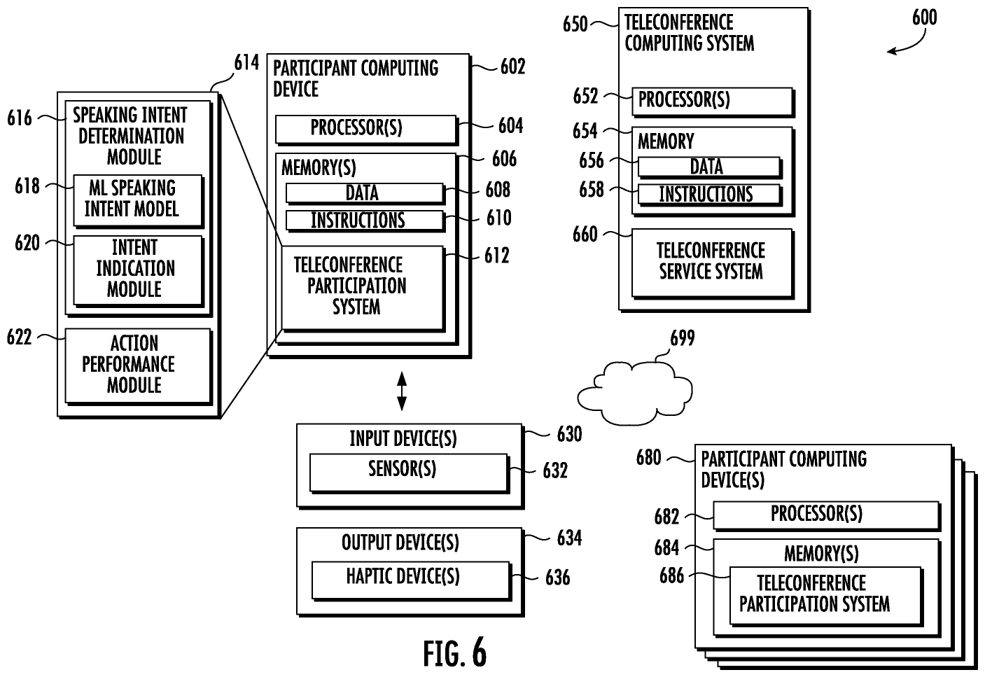

FIG. 6 depicts a block diagram of an example computing environment 600 that performs determination and indication of speaking intent according to example implementations of the present disclosure. The computing environment 600 includes a participant computing device 602 that is associated with a participant in a teleconference, a teleconference computing system 650, and, in some implementations, other participant computing device(s) 680 respectively associated with other participants(s) in the teleconference.

The participant computing device 602 can be any type of computing device, such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.), etc.

In particular, the participant computing device 602 can, in some implementations, be a computing system for determining a speaking intent of a participant (e.g., detecting the performance of a pre-configured speaking intent gesture, etc.) that is using the participant computing device 602 to participate in a teleconference. The participant computing device 602 can also indicate the speaking intent to other participants in the teleconference. For example, the participant computing device 602 can be connected to a teleconference hosted by the teleconference computing system 650. Participant computing device(s) 680 can also be connected to the teleconference. The participant computing device 602 can determine that a participant using the participant computing device 602 intends to speak. The participant computing device 602 can indicate the participant's intent to speak to the participant computing device(s) 680 directly (e.g., directly transmitting information indicating the intent to the device(s) 680 via network 699) or indirectly (e.g., transmitting information indicating the intent to teleconference computing system 650 for relaying to the participant computing device(s) 680).

The participant computing device 602 includes processor(s) 604 and memory(s) 606. The processor(s) 604 can be any suitable processing device (e.g., a processor core, a microprocessor, an ASIC, an FPGA, a controller, a microcontroller, etc.) and can be one processor or processors that are operatively connected. The memory 606 can include non-transitory computer-readable storage media(s), such as RAM, ROM, EEPROM, EPROM, flash memory devices, magnetic disks, etc., and combinations thereof. The memory 606 can store data 608 and instructions 610 which are executed by the processor 604 to cause the participant computing device 602 to perform operations.

In particular, the memory 606 of the participant computing device 602 can include a teleconference participation system 612. The teleconference participation system 612 can facilitate participation in a teleconference by a participant associated with the participant computing device 602 (e.g., a teleconference hosted or otherwise orchestrated by teleconference computing system 650, etc.). To facilitate teleconference participation, the teleconference participation system 612 can include service module(s) 614 which, by providing various services, can collectively facilitate participation in a teleconference.

For example, the teleconference service module(s) 614 can include a speaking intent determination module 616. The speaking intent determination module 616 can determine whether a participant intends to speak as described with regards to FIGS. 1, 3A, and 3B. For example, the speaking intent determination module 616 can include a machine-learned speaking intent model 618 that is trained to process sensor data to determine whether a participant intends to speak, and/or whether a participant has performed a pre-configured speaking intent gesture. For another example, the speaking intent determination module 616 can include an intent indication module 620. The intent indication module 620 can determine whether to generate information indicating the speaking intent of the participant based on the output of the machine-learned speaking intent model 618.

More specifically, the machine-learned speaking intent model 618 can be, or otherwise include, various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). In some implementations, the machine-learned speaking intent model 618 can be received from the teleconference computing system computing system 650 over network 699, stored in the memory 606, and then used or otherwise implemented by the processor(s) 604.

For another example, the teleconference service module(s) 614 can include action performance module 622. The action performance module 622 can perform actions to indicate to the participant using the participant computing device 602 that other participants participating in the teleconference intend to speak. For example, the participant computing device 602 can receive information indicating that some other participant intends to speak from the teleconference computing system 650 (e.g., a participant using one of the participant computing device(s) 680). The action performance module 622 can perform an action (e.g., generate a haptic feedback signal, generate an audio signal, modify an interface of an application facilitating participation in the teleconference, etc.) that indicates to the participant using the participant computing device 602 that some other participant intends to speak.

In some implementations, the participant computing device 602 can include, or can be communicatively coupled to, input device(s) 630. For example, the input device(s) 630 can include a camera device that can capture two-dimensional video data of a participant associated with the participant computing device 602 (e.g., for broadcasting, etc.). In some implementations, the input device(s) 630 can include a number of camera devices communicatively coupled to the participant computing device 602 that are configured to capture image data from different perspectives for generation of three-dimensional pose data/representations (e.g., a representation of a user of the participant computing device 602, etc.).

The participant computing device 602 can also include input device(s) 630 that receive inputs from a participant, or otherwise capture data associated with a participant. For example, the input device(s) 630 can include a touch-sensitive device (e.g., a touch-sensitive display screen or a touch pad) that is sensitive to the touch of a participant input object (e.g., a finger or a stylus). The touch-sensitive device can serve to implement a virtual keyboard. Other example participant input components include a microphone, a traditional keyboard, or other means by which a participant can provide user input.

In particular, the participant computing device 602 can include sensor(s) 632. The sensor(s) 632 can be sensor(s) that can capture sensor data indicative of movements of a participant associated with the teleconference computing system 602 (e.g., accelerometer(s), Global Positioning Satellite (GPS) sensor(s), gyroscope(s), infrared sensor(s), head tracking sensor(s) such as magnetic capture system(s), an omni-directional treadmill device, sensor(s) configured to track eye movements of the user, an IMU, video capture device(s), an audio capture device(s) etc.).

In some implementations, the participant computing device 602 can include, or be communicatively coupled to, output device(s) 634. Output device(s) 634 can be, or otherwise include, device(s) configured to output audio data, image data, video data, etc. For example, the output device(s) 634 can include a two-dimensional display device (e.g., a television, projector, smartphone display device, etc.). For another example, the output device(s) 634 can include display devices for an augmented reality device or virtual reality device.

In particular, the output device(s) 634 can include haptic device(s) 636. The haptic feedback device(s) 636 can be any sort of device sufficient to perform haptic feedback according to a haptic feedback signal. For example, in some implementations the haptic feedback device(s) 636 may include vibrational device(s) (e.g., linear actuator(s), etc.) located within the participant computing device 602 or within a device communicatively coupled to the participant computing device 602 (e.g., wireless earbuds or headphones, etc.). The vibrational device(s) can be configured to vibrate according to a haptic feedback signal (e.g., a linear resonant actuator array, etc.). Additionally, or alternatively, in some implementations the haptic feedback device(s) 636 may include a resistance device (e.g., a brushless DC motor, a magnetic particle brake, etc.) configured to apply a variable resistance to the input device(s) 630 according to the haptic feedback signal (e.g., a brushless direct current motor, etc.).

Additionally, or alternatively, in some implementations the haptic feedback device(s) 124 may include an audio output device. For example, participant computing device 602 can receive information indicating a speaking intent of some other participant of the teleconference. The participant computing device 602 can generate an audio signal for the audio output device to indicate to the participant using the participant computing device 602 that some other participant intends to speak. For example, the participant computing device 602 can adjust the volume, pitch, tone, etc. of the audio output device(s). For another example, the participant computing device 602 can generate an audio signal that includes audio associated with indication of a speaking intent (e.g., a gentle tone or ping, etc.).

The teleconference computing system 650 includes processor(s) 652 and a memory 654. The processor(s) 652 can be any suitable processing device (e.g., a processor core, a microprocessor, an ASIC, an FPGA, a controller, a microcontroller, etc.) and can be one processor or processors that are operatively connected. The memory 654 can include non-transitory computer-readable storage media(s), such as RAM, ROM, EEPROM, EPROM, flash memory devices, magnetic disks, etc., and combinations thereof. The memory 654 can store data 656 and instructions 658 which are executed by the processor 652 to cause the teleconference computing system 650 to perform operations.

In some implementations, the teleconference computing system 650 can be, or otherwise include, a virtual machine or containerized unit of software instructions executed within a virtualized cloud computing environment (e.g., a distributed, networked collection of processing devices), and can be instantiated on request (e.g., in response to a request to initiate a teleconference, etc.). Additionally, or alternatively, in some implementations, the teleconference computing system 650 can be, or otherwise include, physical processing devices, such as processing nodes within a cloud computing network (e.g., nodes of physical hardware resources).

The teleconference computing system 650 can facilitate the exchange of communication data within a teleconference using the teleconference service system 660. More specifically, the teleconference computing system 650 can utilize the teleconference service system 660 to encode, broadcast, and/or relay communications signals (e.g., audio input signals, video input signals, etc.), host chat rooms, relay teleconference invites, provide web applications for participation in a teleconference (e.g., a web application accessible via a web browser at a teleconference computing system, etc.), etc.

More generally, the teleconference computing system 650 can utilize the teleconference service system 660 to handle any frontend or backend services directed to providing a teleconference. For example, the teleconference service system 660 can receive and broadcast (i.e., relay) data (e.g., video data, audio data, etc.) between the participant computing device 602 and participant computing device(s) 680. For another example, the teleconference service system 660 can facilitate direct communications between the participant computing device 602 and participant computing device(s) 680 (e.g., peer-to-peer communications, etc.). A teleconferencing service can be any type of application or service that receives and broadcasts data from multiple participants. For example, in some implementations, the teleconferencing service can be a videoconferencing service that receives data (e.g., audio data, video data, both audio and video data, etc.) from some participants and broadcasts the data to other participants.

As an example, the teleconference service system 660 can provide a videoconference service for multiple participants. One of the participants can transmit audio and video data to the teleconference service system 660 using a participant device (e.g., participant computing device 602, etc.). A different participant can transmit audio data to the teleconference service system 660 with a different participant computing device. The teleconference service system 660 can receive the data from the participants and broadcast the data to each computing system.

As another example, the teleconference service system 660 can implement an augmented reality (AR) or virtual reality (VR) conferencing service for multiple participants. One of the participants can transmit AR/VR data sufficient to generate a three-dimensional representation of the participant to the teleconference service system 660 via a device (e.g., video data, audio data, sensor data indicative of a pose and/or movement of a participant, etc.). The teleconference service system 660 can transmit the AR/VR data to devices of the other participants. In such fashion, the teleconference service system 660 can facilitate any type or manner of teleconferencing services to multiple participants.

It should be noted that the teleconference service system 660 can facilitate the flow of data between participants (e.g., participant computing device 602, participant computing device(s) 680, etc.) in any manner that is sufficient to implement the teleconference service. In some implementations, the teleconference service system 660 can be configured to receive data from participants, decode the data, encode the data, broadcast the data to other participants, etc. For example, the teleconference service system 660 can receive encoded video data from the participant computing device 602. The teleconference service system 660 can decode the video data according to a video codec utilized by the participant computing device 602. The teleconference service system 660 can encode the video data with a video codec and broadcast the data to participant computing devices.

In some implementations, the teleconference computing system 650 includes, or is otherwise implemented by, server computing device(s). In instances in which the teleconference computing system 650 includes multiple server computing devices, such server computing devices can operate according to sequential computing architectures, parallel computing architectures, or some combination thereof.

In some implementations, the transmission and reception of data by teleconference computing system 650 can be accomplished via the network 699. For example, in some implementations, the participant computing device 602 can capture video data, audio data, multimedia data (e.g., video data and audio data, etc.), sensor data, etc. and transmit the data to the teleconference computing system 650. The teleconference computing system 650 can receive the data via the network 699.

In some implementations, the teleconference computing system 650 can receive data from the participant computing device(s) 602 and 680 according to various encryption scheme(s) (e.g., codec(s), lossy compression scheme(s), lossless compression scheme(s), etc.). For example, the participant computing device 602 can encode audio data with an audio codec, and then transmit the encoded audio data to the teleconference computing system 650. The teleconference computing system 650 can decode the encoded audio data with the audio codec. In some implementations, the participant computing device 602 can dynamically select between a number of different codecs with varying degrees of loss based on conditions (e.g., available network bandwidth, accessibility of hardware/software resources, etc.) of the network 699, the participant computing device 602, and/or the teleconference computing system 650. For example, the participant computing device 602 can dynamically switch from audio data transmission according to a lossy encoding scheme to audio data transmission according to a lossless encoding scheme based on a signal strength between the participant computing device 602 and the network 699.

The teleconference computing system 650 and the participant computing device 602 can communicate with the participant computing device(s) 680 via the network 699. The participant computing device(s) 680 can be any type of computing device(s), such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.), or any other type of computing device.

The participant computing device(s) 680 includes processor(s) 682 and a memory 684 as described with regards to the participant computing device 602. Specifically, the participant computing device(s) 680 can be the same, or similar, device(s) as the participant computing device 602. For example, the participant computing device(s) 680 can each include a teleconference participation system 686 that includes at least some of the modules 614 of the teleconference participation system 612. For another example, the participant computing device(s) 680 may include, or may be communicatively coupled to, the same type of input and output devices as described with regards to input device(s) 630 and output device(s) 634 (e.g., device(s) 632, device(s) 636, etc.). Alternatively, in some implementations, the participant computing device(s) 680 can be different devices than the participant computing device 602, but can also facilitate teleconferencing with the teleconference computing system 650. For example, the participant computing device 602 can be a laptop and the participant computing device(s) 680 can be smartphone(s).

The network 699 can be any type of communications network, such as a local area network (e.g., intranet), wide area network (e.g., Internet), or some combination thereof and can include any number of wired or wireless links. In general, communication over the network 699 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

The following definitions provide a detailed description of various terms discussed throughout the subject specification. As such, it should be noted that any previous reference in the specification to the following terms should be understood in light of these definitions.

Broadcast: as used herein, the terms “broadcast” or “broadcasting” generally refers to any transmission of data (e.g., audio data, video data, AR/VR data, etc.) from a central entity (e.g., computing device, computing system, etc.) for potential receipt by one or more other entities or devices. A broadcast of data can be performed to orchestrate or otherwise facilitate a teleconference that includes a number of participants. For example, a central entity, such as a teleconference server system, can receive an audio transmission from a participant computing device associated with one participant and broadcast the audio transmission to a number of participant computing devices associated with other participants of a teleconference session. For another example, a central entity can detect that direct peer-to-peer data transmission between two participants in a private teleconference is not possible (e.g., due to firewall settings, etc.) and can serve as a relay intermediary that receives and broadcasts data transmissions between participant computing devices associated with the participants. In some implementations, broadcast or broadcasting can include the encoding and/or decoding of transmitted and/or received data. For example, a teleconference computing system broadcasting video data can encode the video data using a codec. Participant computing devices receiving the broadcast can decode the video using the codec.

Communications data: as used herein, the term “communications data” generally refers to any type or manner of data that carries a communication, or otherwise facilitates communication between participants of a teleconference. Communications data can include audio data, video data, textual data, augmented reality/virtual reality (AR/VR) data, etc. As an example, communications data can collectively refer to audio data and video data transmitted within the context of a videoconference. As another example, within the context of an AR/VR conference, communications data can collectively refer to audio data and AR/VR data, such as positioning data, pose data, facial capture data, etc. that is utilized to generate a representation of the participant within a virtual environment. As yet another example, communications data can refer to textual content provided by participants (e.g., via a chat function of the teleconference, via transcription of audio transmissions using text-to-speech technologies, etc.).

Cloud: as used herein, the term “cloud” or “cloud computing environment” generally refers to a network of interconnected computing devices (e.g., physical computing devices, virtualized computing devices, etc.) and associated storage media which interoperate to perform computational operations such as data storage, transfer, and/or processing. In some implementations, a cloud computing environment can be implemented and managed by an information technology (IT) service provider. The IT service provider can provide access to the cloud computing environment as a service to various users, who can in some circumstances be referred to as “cloud customers.”

Participant: as used herein, the term “participant” generally refers to any user (e.g., human user), virtualized user (e.g., a bot, etc.), or group of users that participate in a live exchange of data (e.g., a teleconference such as a videoconference, etc.). More specifically, participant can be used throughout the subject specification to refer to user(s) within the context of a teleconference. As an example, a group of participants can refer to a group of users that participate remotely in a teleconference with their own participant computing devices (e.g., smartphones, laptops, wearable devices, teleconferencing devices, broadcasting devices, etc.). As another example, a participant can refer to a group of users utilizing a single participant computing device for participation in a teleconference (e.g., a videoconferencing device within a meeting room, etc.). As yet another example, participant can refer to a bot or an automated user (e.g., a virtual assistant, etc.) that participates in a teleconference to provide various services or features for other participants in the teleconference (e.g., recording data from the teleconference, providing virtual assistant services, providing testing services, etc.)

Teleconference: as used herein, the term “teleconference” generally refers to any communication or live exchange of data (e.g., audio data, video data, AR/VR data, etc.) between multiple participant computing devices. The term “teleconference” encompasses a videoconference, an audioconference, a media conference, an Augmented Reality (AR)/Virtual Reality (VR) conference, and/or other forms of the exchange of data (e.g., communications data) between participant computing devices. As an example, a teleconference can refer to a videoconference in which multiple participant computing devices broadcast and/or receive video data and/or audio data in real-time or near real-time. As another example, a teleconference can refer to an AR/VR conferencing service in which AR/VR data (e.g., pose data, image data, positioning data, audio data, etc.) sufficient to generate a three-dimensional representation of a participant is exchanged amongst participant computing devices in real-time. As yet another example, a teleconference can refer to a conference in which audio signals are exchanged amongst participant computing devices over a mobile network. As yet another example, a teleconference can refer to a media conference in which one or more different types or combinations of media or other data are exchanged amongst participant computing devices (e.g., audio data, video data, AR/VR data, a combination of audio and video data, etc.).

Transmission: As used herein, the term “transmission” generally refers to any sending, providing, etc. of data (e.g., communications data) from one entity to another entity. For example, a participant computing device can directly transmit audio data to another participant computing device. For another example, a participant computing device can transmit video data to a central entity orchestrating a teleconference, and the central entity can broadcast the audio data to other entities participating in the teleconference. Transmission of data can occur over any number of wired and/or wireless communications links or devices. Data can be transmitted in various forms and/or according to various protocols. For example, data can be encrypted and/or encoded prior to transmission and decrypted and/or decoded upon receipt.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
obtaining, by a participant computing device comprising one or more processor devices, sensor data from one or more sensors of the participant computing device, wherein the participant computing device and one or more other participant computing devices are connected to a teleconference orchestrated by a teleconference computing system;
based at least in part on the sensor data, determining, by the participant computing device, that a participant associated with the participant computing device intends to speak to other participants of the teleconference; and
providing, by the participant computing device, information indicating that the participant intends to speak to one or more of:
the teleconference computing system; or
at least one of the one or more other participant computing devices.

2. The computer-implemented method of claim 1, wherein the one or more sensors of the participant computing device comprise at least one of:
a camera;
a microphone;
a button;
a touch surface;
an Inertial Measurement Unit (IMU);
a gyroscope; or
an accelerometer.

3. The computer-implemented method of claim 2, wherein determining that the participant associated with the participant computing device intends to speak comprises:
processing, by the participant computing device, the sensor data with a machine-learned speaking intent model to obtain a speaking intent output indicating that the participant associated with the participant computing device intends to speak.

4. The computer-implemented method of claim 3, wherein processing the sensor data with the machine-learned speaking intent model comprises processing, by the participant computing device, the sensor data with the machine-learned speaking intent model to obtain a speaking intent output indicating performance of a pre-configured speaking intent gesture by the participant.

5. The computer-implemented method of claim 3, wherein, prior to determining that the participant associated with the participant computing device intends to speak, the operations comprise:
receiving, by the participant computing device, audio data comprising audio captured by at least one of the one or more other participant computing devices; and
processing, by the participant computing device, the audio data with a machine-learned speech recognition model to obtain a speech recognition output indicating whether a conversation between participants has ended; and
wherein determining that the participant associated with the participant computing device intends to speak comprises determining, by the participant computing device, that the participant associated with the participant computing device intends to speak based on the speech recognition output and the speaking intent output.

6. The computer-implemented method of claim 1, wherein the method further comprises:
receiving, by the participant computing device, information indicating that a second participant associated with one of the one or more other participant computing devices intends to speak; and
responsive to the information indicating that the second participant intends to speak, performing, by the participant computing device, one or more actions to indicate, to the participant associated with the participant computing device, that some other participant of the teleconference intends to speak.

7. The computer-implemented method of claim 6, wherein performing the one or more actions comprises causing, by the participant computing device, playback of audio with an audio output device associated with the participant computing device, wherein the audio indicates to the participant that some other participant intends to speak.

8. The computer-implemented method of claim 6, wherein performing the one or more actions comprises generating, by the participant computing device, a haptic feedback signal for one or more haptic feedback devices associated with the participant computing device, wherein the haptic feedback signal indicates that some other participant intends to speak.

9. The computer-implemented method of claim 6, wherein performing the one or more actions comprises making, by the participant computing device, a modification to an interface of an application that facilitates participation in the teleconference, wherein the interface of the application is displayed within a display device associated with the participant computing device, and wherein the modification indicates that some other participant intends to speak.

10. A participant computing device, comprising:
one or more processors;
one or more sensors;
one or more non-transitory computer-readable media that store instructions that, when executed by the one or more processors, cause the participant computing device to perform operations, the operations comprising:
connecting to a teleconference orchestrated by a teleconference computing system, wherein the participant computing device is associated with a participant of the teleconference;
receiving information indicating that a second participant of the teleconference intends to speak, wherein the second participant is associated with a second participant computing device that is connected to the teleconference, wherein the information indicating that the participant of the teleconference intends to speak is determined based at least in part on sensor data captured at second participant computing device; and
responsive to the information indicating that the second participant intends to speak, performing one or more actions to indicate, to the participant associated with the participant computing device, that some other participant of the teleconference intends to speak.

11. The participant computing device of claim 10, wherein performing the one or more actions comprises causing playback of audio with an audio output device associated with the participant computing device, wherein the audio indicates to the participant that some other participant intends to speak.

12. The participant computing device of claim 10, wherein performing the one or more actions comprises generating a haptic feedback signal for one or more haptic feedback devices associated with the participant computing device, wherein the haptic feedback signal indicates that some other participant intends to speak.

13. The participant computing device of claim 10, wherein performing the one or more actions comprises making a modification to an interface of an application that facilitates participation in the teleconference, wherein the interface of the application is displayed within a display device associated with the participant computing device, and wherein the modification indicates that some other participant intends to speak.

14. The participant computing device of claim 10, wherein the operations further comprise:
obtaining sensor data from the one or more sensors of the participant computing device;
based at least in part on the sensor data, determining that the participant associated with the participant computing device intends to speak to the other participants of the teleconference; and
providing information indicating that the participant intends to speak to one or more of:
the teleconference computing system; or
at least one of the one or more other participant computing devices.

15. The participant computing device of claim 14, wherein the one or more sensors of the participant computing device comprise at least one of:
a camera;
a microphone;
a button;
a touch surface;
an Inertial Measurement Unit (IMU);
a gyroscope; or
an accelerometer.

16. The participant computing device of claim 15, wherein determining that the participant associated with the participant computing device intends to speak comprises processing the sensor data with the machine-learned speaking intent model to obtain a speaking intent output indicating performance of a pre-configured speaking intent gesture by the participant.

17. One or more non-transitory computer-readable media that store instructions that, when executed by one or more processors of a teleconference computing system, cause the teleconference computing system to perform operations, the operations comprising:
receiving, from a participant computing device, speaking intent information from a participant computing device of a plurality of participant computing devices connected to a teleconference orchestrated by the teleconference computing system, wherein the speaking intent information indicates that a participant associated with the participant computing device intends to speak;
making an evaluation of one or more indication criteria based on the speaking intent information; and
based on the evaluation, instructing a second participant computing device of the plurality of participant computing devices connected to the teleconference to perform one or more actions to indicate, to a second participant associated with the second participant computing device, that some other participant of the teleconference intends to speak.

18. The one or more non-transitory computer-readable media of claim 17, wherein the one or more indication criteria comprise at least one of:
a number of times that a speaking intent has been previously indicated for the participant associated with the participant computing device;
a degree of certainty associated with the speaking intent information; or
a connection quality associated with a connection of the participant computing device to the teleconference; or
a number of other participant computing devices of the plurality of participant computing devices that have also provided speaking intent information to the teleconference computing system.

19. The one or more non-transitory computer-readable media of claim 17, wherein receiving the speaking intent information from the participant computing device further comprises receiving additional speaking intent information from a third participant computing device of the plurality of participant computing devices, wherein the speaking intent information indicates that a third participant associated with the third participant computing device intends to speak; and
wherein the one or more indication criteria comprises a priority criteria indicative of a degree of speaking priority for the participant computing device and the third participant computing device.

20. The one or more non-transitory computer-readable media of claim 19, wherein making the evaluation of one or more indication criteria based on the speaking intent information comprises:
determining a priority metric for the participant computing device based on the evaluation of the one or more indication criteria for the participant computing device;
determining a priority metric for the third participant computing device based on an evaluation of the one or more indication criteria for the third participant computing device; and
based on the priority metric for the participant computing device and the priority metric for the third participant computing device, selecting the participant computing device for indication of speaking intent.
